(19) United States
(12) Patent Application Publication
(10) Pub. No.: US 2022/0133063 A1
(43) Pub. Date: May 5, 2022

(54) DISPLAY SYSTEM, DISPLAY METHOD, AND COMPUTER PROGRAM PRODUCT

(71) Applicant: KATSUNORI SUETSUGU, TOKYO (JP)

(72) Inventor: KATSUNORI SUETSUGU, TOKYO (JP)

(21) Appl. No.: 17/493,978

(22) Filed: Oct. 5, 2021

(30) Foreign Application Priority Data
Oct. 30, 2020 (JP) 2020-182601

(51) Int. Cl. A47F 7/19; G06T 15/10

(52) U.S. Cl. CPC A47F 7/19; A47F 8/02; A47F 2007/195; G06T 15/10

(57) ABSTRACT

Provided is a display system, display method, and computer program product that allow a user to not only check the sizes of clothing but also check whether the user is wearing the clothing well even if the user does not actually try on the clothing.

A display system is used to sell clothing, and represents a mannequin and clothing in three-dimensional shapes using computer graphics, forms a three-dimensional shape representing a state in which the mannequin is wearing the clothing, by combining the three-dimensional shapes of the mannequin and the clothing, and displays the formed three-dimensional shape. When forming the three-dimensional shape representing the state in which the mannequin is wearing the clothing, the display system represents deformation of the clothing by inputting physical properties of the clothing.

### TECHNICAL FIELD

The present invention relates to a display system, display method, and computer program product that display a three-dimensional shape representing a state in which a mannequin is wearing clothing.

### BACKGROUND ART

With respect to clothing sold at a real store or clothing sold by mail order on the Internet, users have had a desire to check whether the clothing fits their body shape and further a desire to check whether the users are wearing the clothing well by checking a state in which the users wearing the clothing are taking various poses, from the front, rear, left, and right, even if the users do not actually try on the clothing.

Examples of background art relating to clothing include a technology that inputs, to a computer, various types of information on a wearer obtained from clothing (for example, see Japanese Patent Application Publication (Translation of PCT Application) No. 2017-517293). There is also software for displaying a state in which a character is trying on clothing, on a computer screen (for example, see Japanese Patent Application Publication No. 2008-165807, International Publication No. WO 2016/158896, and [Blender 2.8] Representation of Cloth [Cloth Simulation] https://horohorori.com/blender-note/physics-simulations/about-cloth-simulation).

### SUMMARY OF INVENTION

The above background art has difficulty in allowing a user to check, on a computer screen, a state in which the user is trying on clothing being sold at a real store or an electronic commerce (EC) site or check, on a computer screen, whether the user is wearing the clothing well when the user is taking poses.

An object of the present invention is to provide a display system, display method, and computer program product that, even if a user does not actually try on clothing, allow the user to not only check the sizes of the clothing but also check whether the user is wearing the clothing well.

A display system according to the present invention that is used to sell clothing comprises a mannequin 3D generator that represents a mannequin in three-dimensional shapes using computer graphics; a clothing 3D generator that represents a clothing in three-dimensional shapes using computer graphics; a wearing 3D generator that forms a three-dimensional shape representing a state in which the mannequin is wearing the clothing, by combining the three-dimensional shapes of the mannequin and the clothing; and a display unit that displays the formed three-dimensional shape. When the wearing 3D generator forms the three-dimensional shape representing the state in which the mannequin is wearing the clothing, the wearing 3D generator represents deformation of the clothing by inputting physical properties of the clothing.

According to this invention, when creating the three-dimensional shape representing the state in which the mannequin is wearing the clothing, the deformation of the clothing is represented by inputting the physical properties of the clothing. Thus, even if the user does not actually wear the clothing, the user is able to not only check the sizes of the clothing but also check whether the user is wearing the clothing well.

In the display system, the three-dimensional shape of the mannequin has a bone representing a fold at a joint of the mannequin and is changed in accordance with the fold of the bone.

According to this invention, the shape is changed in accordance with the fold of the bone. Thus, a state in which the mannequin is wearing the clothing and moving the body is represented, and the user is able to check whether the user is wearing the clothing well.

A display method according to the present invention is a display method that is used to sell clothing comprises representing a mannequin and clothing in three-dimensional shapes using computer graphics; forming a three-dimensional shape representing a state in which the mannequin is wearing the clothing, by combining the three-dimensional shapes of the mannequin and the clothing; and displaying the formed three-dimensional shape. The three-dimensional shape of the mannequin is obtained from a shape of the mannequin, the three-dimensional shape of the clothing is obtained from a shape of the clothing, and a mannequin to be used is determined from among multiple previously prepared mannequins.

According to this invention, the mannequin to be used is determined from among the previously prepared multiple mannequins. Thus, a three-dimensional shape representing a state in which a mannequin close to the body shape of the user is wearing the clothing is formed. If the mannequin to be used is determined on the basis of a user input, a state in which the mannequin selected by the user is trying on the clothing is displayed even if a change is made in the body shape of the user.

In the display method according to the present invention,
when determining the mannequin to be used from among a plurality of previously prepared mannequins, presenting to the user a result of automatic selection using AI or based on the past history of mannequin use by the user to let the user manually input correction or approval of the result.

According to this invention, the user is able to select a mannequin close to the current body shape of the user even if there is a change in the body shape of the user. Thus, the user is able to check a state in which the mannequin is trying on the clothing.

In the display method according to the present invention, when obtaining the three-dimensional shape of the clothing from the shape of the clothing, a state in which the mannequin is wearing the clothing is used.

According to this invention, the three-dimensional shape of the clothing is easily obtained on the basis of the shape of the clothing being worn by the mannequin.

A computer program product according to the present invention is a computer program product that is used to sell clothing and to cause a computer to perform a function of representing a mannequin and clothing in three-dimensional shapes using computer graphics, a function of forming a three-dimensional shape representing a state in which the mannequin is wearing the clothing, by combining the three-dimensional shapes of the mannequin and the clothing, and a function of displaying the three-dimensional shape. When forming the three-dimensional shape representing the state in which the mannequin is wearing the clothing, deformation of the clothing is represented by inputting physical properties of the clothing.

According to this invention, when forming the three-dimensional shape representing the state in which the mannequin is wearing the clothing, the deformation of the clothing is represented by inputting the physical properties of the clothing. Thus, even if the user does not actually try on the clothing, the user is able to not only check the sizes of the clothing but also check whether the user is wearing the clothing well.

A computer program product according to the present invention is a computer program product that is used to sell clothing and to cause a computer to perform a function of representing a mannequin and clothing in three-dimensional shapes using computer graphics, a function of forming a three-dimensional shape representing a state in which the mannequin is wearing the clothing, by combining the three-dimensional shapes of the mannequin and the clothing, and a function of displaying the three-dimensional shape. The three-dimensional shape of the mannequin is obtained from a shape of the mannequin, the three-dimensional shape of the clothing is obtained from a shape of the clothing, and a mannequin to be used is determined from among previously prepared multiple mannequins.

According to this invention, the mannequin to be used is determined from among the previously prepared multiple mannequins. Thus, a three-dimensional shape representing a state in which a mannequin close to the body shape of the user is wearing the clothing is formed.

The display system according to the present invention represents the deformation of the clothing in accordance with the inputted physical properties of the clothing. Thus, even if the user does not actually try on the clothing, the user can check not only the sizes of the clothing but also check whether the user is wearing the clothing well.

### BRIEF DESCRIPTION OF THE DRAWINGS

FIG. 1 is a drawing showing the overall configuration of a display system according to the present invention;

FIG. 2 is a diagram showing the functional configuration of a server; and

FIG. 3 is a flowchart showing the steps of a display method performed by the display system.

### DESCRIPTION OF EMBODIMENTS

Now, an embodiment of the present invention will be described in detail with reference to the drawings.

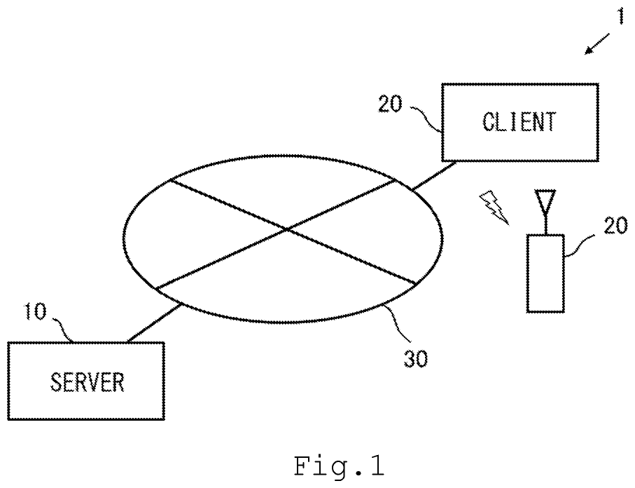

FIG. 1 is a drawing showing the overall configuration of a display system 1 according to an embodiment of the present invention. As shown in FIG. 1, the display system 1 includes a server 10 that forms a three-dimensional shape representing a state in which a mannequin is wearing clothing, a client 20 placed in a real store that sells clothing or owned by a user who uses EC sites on the Internet, and a communication network 30, such as the Internet or a wireless communication network, that communicatively connects the server 10 and client 20.

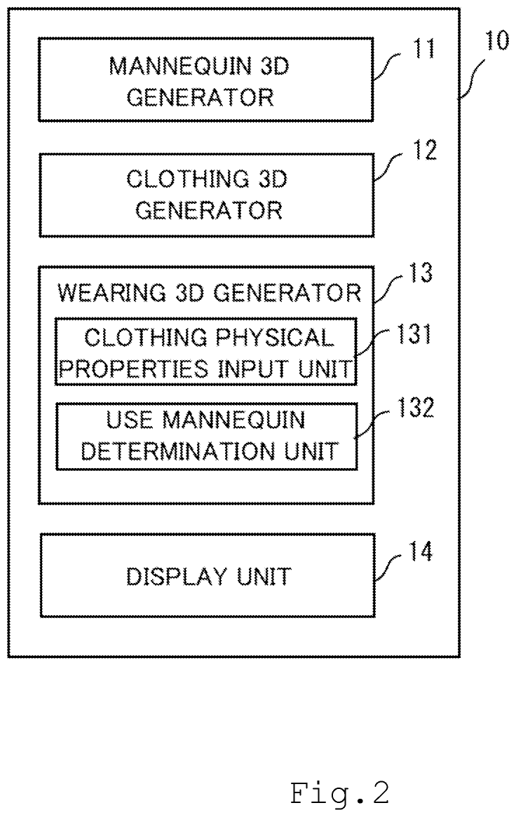

The server 10 includes, as hardware, a CPU, a storage device including RAM, ROM, and hard disk, a communication interface that enables communication through the communication network 30, and input/output interfaces such as a keyboard and a display. The storage device of the server 10 is storing various types of data, a database, and software such as programs. Examples of the data stored in the storage device include data on previously prepared (that is, generated and stored) mannequins having various shapes, previously inputted physical properties of clothing that are being sold at real stores or EC sites, the history of use of the display system 1 by the user, and the like. The programs stored in the storage device include a program for representing mannequins and clothing in three-dimensional shapes using computer graphics, a program for forming and displaying a three-dimensional shape representing a state in which a mannequin is wearing clothing, by combining the shapes of the mannequin and clothing, a program for, when forming the three-dimensional shape representing the state in which the mannequin is wearing the clothing, representing the deformation of the clothing by inputting the physical properties of the clothing, a program for determining a mannequin to be used from among the previously prepared multiple mannequins, and the like. When the CPU of the server 10 performs processing in accordance with software stored in the storage device, the functional elements shown in FIG. 2 are implemented on the server 10.

A mannequin 3D generator 11 generates, from the shape of a mannequin, mannequin 3D data representing the mannequin in a three-dimensional shape using computer graphics. The three-dimensional shape of the mannequin has bones representing folds at the joints of the mannequin. The mannequin 3D generator 11 changes the three-dimensional shape of the mannequin in accordance with the folds of the bones.

A known technology may be used as a method for setting the bones representing folds at the joints of the mannequin. For example, a user sets bones inside generated mannequin polygon data and associates the bones with the polygon data using known software included in the display system 1. Thus, the mannequin 3D generator 11 forms the three-dimensional shape of the mannequin in which the bones are set, on the basis of information inputted by the user.

As seen above, the three-dimensional shape of the mannequin has the bones representing folds at the joints of the mannequin and is deformed in accordance with the folds of the bones. Thus, the mannequin 3D generator is able to accurately represent a state in which the mannequin is wearing the clothing and moving the body. As a result, the user is able to check whether the user is wearing the clothing well by using a mannequin close to the body shape of the user.

A clothing 3D generator 12 generates clothing 3D data representing a three-dimensional shape of clothing, using computer graphics. The “clothing” here include all clothing that the mannequin can wear, such as a hat, glasses, a mask, earphones, a bag, a ring, an accessory, shoes, a muffler, a scarf, gloves, a belt, and a wallet.

Methods for generating the clothing 3D data representing the three-dimensional shape of the clothing include a method of directly three-dimensionally scanning the clothing, inputting obtained scan data to the server 10, and processing the data, a method of sewing the clothing using a body and paper pattern for draping, a method of, with respect to clothing that fits the body, such as underwear, generating data by drawing a line from a body for draping and floating the thickness of a textile or the like, and others.

In the present embodiment, the clothing 3D generator 12 obtains the three-dimensional shape of the clothing on the basis of the shape of the clothing worn by the mannequin. Thus, the three-dimensional shape of the clothing is easily obtained.

A wearing 3D generator 13 generates three-dimensional shape data representing a state in which the mannequin is wearing the clothing (hereafter referred to as the “wearing 3D data”), by combining the mannequin 3D data generated by the mannequin 3D generator 11 and the clothing 3D data generated by the clothing 3D generator 12 using computer graphics. Note that the wearing 3D data created may be data for displaying a virtual reality (VR) environment or an augmented reality (AR) environment or may be data for displaying as a 3D hologram.

Examples of a method for generating the wearing 3D data include a method of combining the already generated clothing 3D data and mannequin 3D data, a method of placing the clothing on the mannequin in a natural manner by executing a physics engine between a cloth, paper pattern, or the like and the mannequin 3D data and then sewing the clothing and the cloth, paper pattern, or the like together, and a method of, with respect to clothing that fits the body, such as underwear, generating data by drawing a line on the mannequin, a body for draping, or the like and adding thickness. To create such wearing 3D data, any known software may be used. For example, a function called “cloth simulation” of the existing open source software “Blender” may be used.

The wearing 3D generator 13 includes a clothing physical properties input unit 131 and a use mannequin determination unit 132. When generating the wearing 3D data representing the state in which the mannequin is wearing the clothing, the clothing physical properties input unit 131 represents the deformation of the clothing by inputting the physical properties of the clothing. Examples of the physical properties of the clothing include the mass, tensile stress, shearing stress, compressive stress, bending stress, and the like of the clothing. Such data may be previously registered in the database of the server 10 for each of the types of textiles of clothing sold at real stores or EC sites, or may be inputted to the server 10 by a salesclerk of a real store when attending to a customer.

The use mannequin determination unit 132 determines a mannequin to be used from among multiple mannequins having various shapes previously stored in the database of the server 10. Conceivable methods for determining a mannequin to be used include automatic selection using AI, automatic selection based on the past history of mannequin use by the user, manual selection based on a user input, combinations of these, and the like. For example, one conceivable combination is a method of presenting the result of automatic selection to the user so that the user manually inputs correction or approval of the presented result. If a mannequin to be used is determined on the basis of a user input, the user is able to select a mannequin close to the current body shape of the user even if there is a change in the body shape of the user. Thus, the user is able to check a state in which the mannequin is trying on the clothing.

Examples of a method for causing the user to input a mannequin to be used include a method of causing the user to input rough sizes, age, and the like in accordance with input items displayed on the screen of the display of the client 20, further causing the user to input the shoulder width, leg length, waist size, and the like, and to send these pieces of information to the server 10 and a method of causing a salesclerk in a real store to measure and input the thicknesses and lengths of the legs and arms of the user.

A display unit 14 sends the wearing 3D data generated by the wearing 3D generator 13 to the client 20 owned by the user who uses real stores or EC sites so that the state in which the mannequin is wearing the clothing is displayed on the display of the client 20. The state may be displayed on the display of the server 10 Instead of that of client 20. If the wearing 3D data is data for displaying in a virtual reality (VR) environment or an augmented reality (AR) environment, or data for displaying as a 3D hologram, the display unit 14 displays the wearing 3D data in a virtual space or a real space, or on a display or the like in accordance with a corresponding display technology.

The client 20 is a computer that is able to display the wearing 3D data sent from the server 10. It may be a portable informatiojin terminal owned by the user who uses EC sites on the Internet, or may be a monitor device installed in a real store.

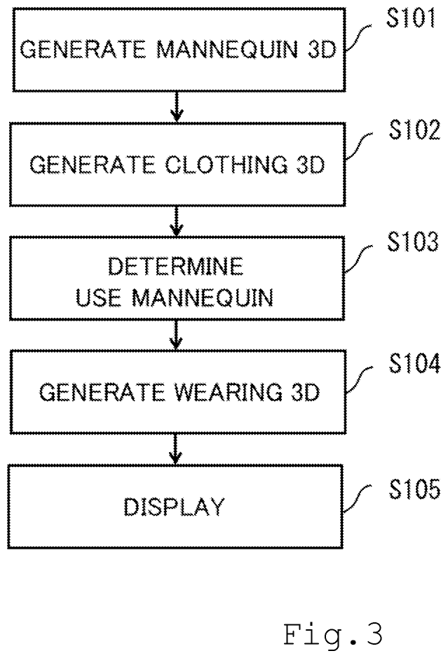

Next, referring to a flowchart shown in FIG. 3, the steps of a display method performed by the display system 1 will be described.

The mannequin 3D generator 11 of the server 10 obtains a three-dimensional shape of a mannequin from the shape of the mannequin (step S101).

The clothing 3D generator 12 of the server 10 obtains a three-dimensional shape of clothing from the shape of the clothing worn by the mannequin (step S102).

The use mannequin determination unit 132 of the server determines a mannequin to be used from among multiple mannequins having various shapes previously stored in the database of the server 10 (step S103). Specifically, for example, the use mannequin determination unit 132 determines a mannequin to be used using AI or on the basis of the past history and presents the obtained result to the user so that the user checks the result. If the user does an input for correction, a mannequin to be used is determined on the basis of the input; if the user does an input for approval, a mannequin to be used is determined in accordance with the result obtained using AI or on the basis of the past history.

The wearing 3D generator 13 generates wearing 3D data representing a state in which the mannequin to be used determined in step S103 is wearing the clothing, by combining mannequin 3D data representing a three-dimensional shape of this mannequin and the clothing 3D data representing the three-dimensional shape of the clothing (step S104).

The display unit 14 of the server 10 sends the wearing 3D data generated by the wearing 3D generator 13 to the client 20. The client 20 receives the wearing 3D data from the server 10 and displays the three-dimensional shape representing the state in which the mannequin is wearing the clothing (step S105). Thus, the user is able to check a state in which the user is wearing the clothing being sold at a real store or an EC site and to check whether the user is wearing the clothing well when taking poses.

As described above, the three-dimensional shape of the mannequin has the bones, the mannequin to be used is determined on the basis of an automatic input or user input, and the deformation of the clothing is represented in accordance with the inputted physical properties of the clothing. Thus, even if the user himself or herself does not actually try on the clothing, the user is able to not only check the sizes of the clothing but also check whether the user is wearing the clothing well.

The above embodiment is illustrative only, and the present invention can also be carried out by making various modifications to the embodiment without departing from the spirit and scope of the invention as set forth in the claims.

For example, the communication system of the display system 1 is not limited to client-server communication as in the above embodiment. For example, the communication system may be peer-to-peer (P2P) communication or block chain communication, may be communication using a distributed storage block chain, or may be a communication system in which these are combined.

While, in the above embodiment, the display system 1 has been described as including the server 10 and client 20 as elements, the display system 1 need not include these elements and, for example, may consist of a single device or may consist of multiple nodes forming a block chain. If the display system 1 consists of a single device, this device may be a stand-alone device that is not connected to the communication network 30, such as the Internet.

Clothing sold through the display system 1 according to the present invention is not limited to clothing that the user can actually wear and may be digital clothing. When the user purchases digital clothing, the user may view it for decorative purposes, or may put it on a character in a computer game, movie, or the like, or may put it on a character serving as the user's avatar that makes communication on the Internet or in a local computer environment that is not connected to the Internet, or may use it to create actual clothing. Clothing may be sold through IoT rather than EC sites.

The method for determining a mannequin to be used performed by the use mannequin determination unit 132 described in the above embodiment is illustrative only, and various methods are conceivable. For example, one conceivable method involves first selecting a mannequin corresponding to the brand image of clothing that the store wants to sell, by default and then selecting a mannequin in accordance with the user. Specifically, this method involves first presenting a mannequin selected by default to the user and then causing the user to manually input a selection as to whether the user approves or changes the presented mannequin, in accordance with the preference or body shape of the user.

The present invention can be used as a pseudo try-on system when selling clothing or when creating clothing. The present invention can also be used to enjoy a clothing change on a computer game or SNS.

What is claimed is:

1. A display system that is used to sell clothing, comprising: a mannequin 3D generator that represents a mannequin in three-dimensional shapes using computer graphics; a clothing 3D generator that represents a clothing in three-dimensional shapes using computer graphics; a wearing 3D generator that forms a three-dimensional shape representing a state in which the mannequin is wearing the clothing, by combining the three-dimensional shapes of the mannequin and the clothing; and a display unit that displays the formed three-dimensional shape, wherein when the wearing 3D generator forms the three-dimensional shape representing the state in which the mannequin is wearing the clothing, the wearing 3D generator represents deformation of the clothing by inputting physical properties of the clothing.

2. The display system of claim 1, wherein the three-dimensional shape of the mannequin has a bone representing a fold at a joint of the mannequin and is changed in accordance with the fold of the bone.

3. A display method that is used to sell clothing, comprising: representing a mannequin and clothing in three-dimensional shapes using computer graphics; forming a three-dimensional shape representing a state in which the mannequin is wearing the clothing, by combining the three-dimensional shapes of the mannequin and the clothing; and displaying the formed three-dimensional shape, wherein
the three-dimensional shape of the mannequin is obtained from a shape of the mannequin,
the three-dimensional shape of the clothing is obtained from a shape of the clothing, and
a mannequin to be used is determined from among a plurality of previously prepared mannequins.

4. The display method of claim 3, wherein when determining the mannequin to be used from among a plurality of previously prepared mannequins, presenting to the user a result of automatic selection using AI or based on the past history of mannequin use by the user to let the user manually input correction or approval of the result.

5. The display method of claim 3, wherein when obtaining the three-dimensional shape of the clothing from the shape of the clothing, a state in which the mannequin is wearing the clothing is used.

6. A computer program product that is used to sell clothing and to cause a computer to perform a function of representing a mannequin and clothing in three-dimensional shapes using computer graphics, a function of forming a three-dimensional shape representing a state in which the mannequin is wearing the clothing, by combining the three-dimensional shapes of the mannequin and the clothing, and a function of displaying the three-dimensional shape, wherein when forming the three-dimensional shape representing the state in which the mannequin is wearing the clothing, deformation of the clothing is represented by inputting physical properties of the clothing.

7. A computer program product that is used to sell clothing and to cause a computer to perform a function of representing a mannequin and clothing in three-dimensional shapes using computer graphics, a function of forming a three-dimensional shape representing a state in which the mannequin is wearing the clothing, by combining the three-dimensional shapes of the mannequin and the clothing, and a function of displaying the three-dimensional shape, wherein
the three-dimensional shape of the mannequin is obtained from a shape of the mannequin,
the three-dimensional shape of the clothing is obtained from a shape of the clothing, and
a mannequin to be used is determined from among a plurality of previously prepared mannequins.
